(19) United States
(12) Patent Application Publication
(10) Pub. No.: US 2006/0002575 A1
(43) Pub. Date: Jan. 5, 2006

(54) Microphone device

(75) Inventor: Hiroshi Akino, Machida-shi (JP)

Correspondence Address: KANESAKA BERNER AND PARTNERS LLP, SUITE 300, 1700 DIAGONAL RD, ALEXANDRIA, VA, 22314-2848, US

(73) Assignee: KABUSHIKI KAISHA AUDIO-TECHNICA, Machida-shi (JP)

(21) Appl. No.: 11/167,091

(22) Filed: Jun. 28, 2005

(30) Foreign Application Priority Data
Jun. 30, 2004 (JP) 2004-193457

(51) Int. Cl. H04R 11/04; H04R 17/02; H04R 3/00

(52) U.S. Cl. 381/361; 381/122

(57) ABSTRACT

There is provided a microphone device for preventing spark discharge caused by static electricity when a speaker touches a flexible pipe supporting a microphone, thereby preventing noise on an audio signal. A flock layer 11 is provided in which short fibers 13 are electrostatically flocked on a periphery 3 of a flexible pipe 2 via a conductive adhesive 12, and antistatic treatment is performed on the flock layer 11. With this configuration, even when a charged speaker touches the flexible pipe 2, noise caused by spark discharge can be eliminated on an audio signal generated by the microphone.

### TECHNICAL FIELD

The present invention relates to a gooseneck microphone device in which a microphone is supported on the end of a flexible pipe and more specifically relates to a microphone device for eliminating noise on an audio signal by preventing spark discharge caused by static electricity when a speaker touches a flexible pipe.

### BACKGROUND ART

As a microphone device used in a conference room and so on, a gooseneck microphone is frequently used in which a microphone unit is supported on the end of a flexible pipe to easily direct the microphone to the mouth of a speaker.

In the case of a condenser microphone, a microphone unit has a high impedance and thus an impedance converter such as an FET is used. Further, an output circuit, a low cut circuit, and so on are often included to obtain satisfactory performance and function.

FIG. 2 is a sectional view showing an example of a microphone device which is conventionally used in conferences and comprises a flexible pipe. A microphone device 1 has a unit body 4 which houses necessary circuits on the base end of a flexible pipe 2 (the lower end of FIG. 2) and a microphone 5 including a microphone unit 6 on the top end of the flexible pipe 2.

The microphone device 1 includes an impedance converter on the side of the microphone unit 6 to make the microphone 5 inconspicuous. A circuit housing part for housing an output circuit, a low cut circuit, and so on (not shown) is provided on the side of the unit body 4 of the flexible pipe 2. The circuit housing part and the impedance converter are connected to each other via a dedicated cable. The audio signal of the microphone 5 is outputted from the output circuit included in the circuit housing part.

In the case of the microphone device 1 comprising the flexible pipe 2, a speaker often directly touches the flexible pipe 2 when adjusting the microphone 5 to his/her mouth during a conference or the like. On the other hand, carpets are used on floors in some conference facilities, and static electricity is produced because a speaker walks on carpets when moving from his/her seat to the speaker's stand.

In this way, when a speaker carrying static electricity touches the flexible pipe 2, spark discharge serving as a source of electromagnetic waves is produced between the flexible pipe 2 and a human body, so that noise may occur on the audio signal of the microphone 5. Although the occurrence of this phenomenon can be reduced to some extent by positively providing electrostatic shielding for the microphone, the occurrence of noise cannot be avoided.

On the other hand, Patent Document 1 (Japanese Patent Application Publication No. H06-38287) discloses a microphone head which is covered with a microphone protector having an infinite number of short fibers implanted on a surface of a microphone. The short fibers are disinfected and a deodorant is absorbed therein.

However, the conventional technique disclosed in Patent Document 1 only aims to cover the microphone head with the microphone protector for sanitary use but does not aim to eliminate noise, which is caused by static electricity, on the audio signal of the microphone. Any other conventional techniques using electrostatic flocking cannot effectively prevent noise.

### SUMMARY OF THE INVENTION

In view of the problem of the conventional technique, an object of the present invention is to provide a microphone device for eliminating noise on an audio signal by preventing spark discharge when a speaker touches a flexible pipe supporting a microphone.

The present invention is devised to attain the object. A microphone device comprising a unit body for housing necessary circuits on the base end of a flexible pipe and a microphone including a microphone unit on the top end of the flexible pipe, wherein the flexible pipe has a flock layer in which short fibers are electrostatically implanted via a conductive adhesive on the periphery of the flexible pipe, and the flock layer is subjected to antistatic treatment.

The antistatic treatment is to apply an antistatic agent capable of dissipating static electricity.

With this configuration, the flock layer is provided in which short fibers are electrostatically implanted via the conductive adhesive applied to the periphery of the flexible pipe, and the flock layer is subjected to antistatic treatment. Thus, the short fibers constituting the flock layer keep a proper resistance value, static electricity carried by a speaker can be slowly transferred to the microphone, a discharging speed is reduced, and thus spark discharge is prevented, thereby eliminating noise on the audio signal.

### BRIEF DESCRIPTION OF THE DRAWINGS

FIG. 1 is an enlarged view mainly showing that short fibers are electrostatically flocked on a flexible pipe of a microphone device shown in FIG. 2; and

FIG. 2 is a sectional view showing a main part of the microphone device used for conferences or the like, the microphone device comprising a flexible pipe.

### DETAILED DESCRIPTION

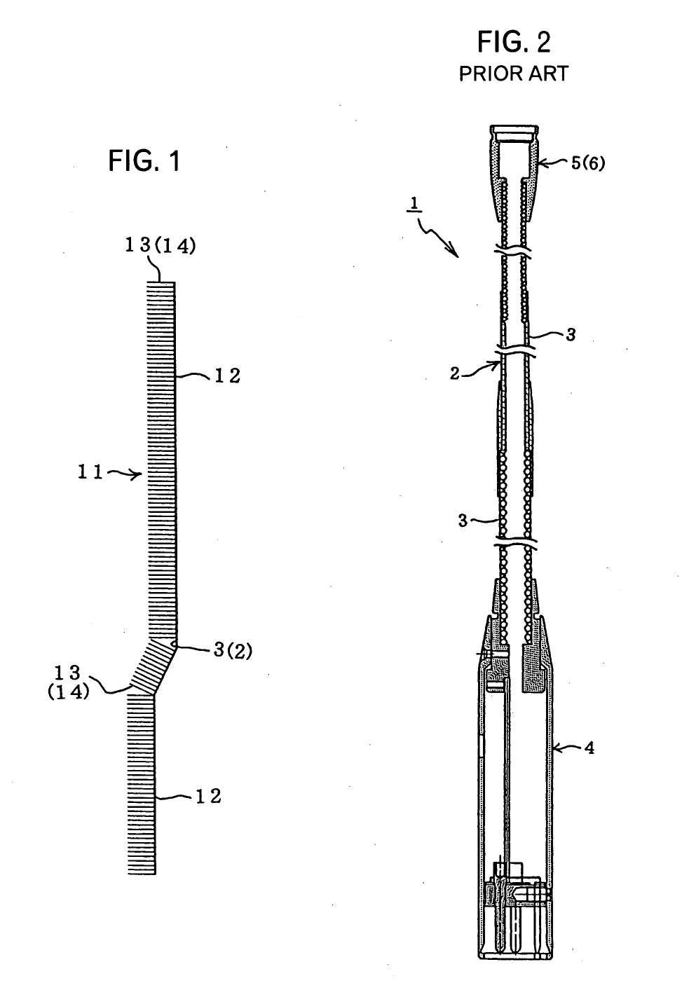

FIG. 1 is an enlarged view mainly showing that short fibers are electrostatically flocked on the flexible pipe of the microphone device shown in FIG. 2. A flexible pipe 2 shown in FIG. 2 is formed so as not to be extendable and has a predetermined length.

A conductive adhesive (e.g., an adhesive known under the trade name of “Dotite”, FUJIKURA KASEI, CO., LTD.) 12 is applied to a periphery 3 of the flexible pipe 2. Short fibers 13 of piles or the like are electrostatically flocked on the conductive adhesive 12. With this configuration, a part touched by a speaker on the flexible pipe 2 has a flock layer 11 in which the short fibers 13 are densely raised. In this example, the flock layer 11 is formed on the part touched by a speaker on the flexible pipe 2. The flock layer 11 may be formed over the flexible pipe 2 when necessary.

On the flock layer 11 formed thus, an antistatic agent 14 capable of dissipating static electricity is, for example, sprayed or applied to perform antistatic treatment. With this configuration, the short fibers 13 having been made conductive are densely raised on the periphery 3 of the part touched by a speaker on the flexible pipe 2, so that the flexible pipe 2 cannot be directly touched by a hand. A liquid methanol (solvent) having a surface resistance of about 10⁸ to 10⁹ Ω can be preferably used as the antistatic agent 14.

Therefore, according to the present invention, when a charged human body comes close to the ends of the short fibers 13 having small diameters, an uneven electric field appears between the human body and the short fibers 13, and static electricity is likely to be discharged from the human body. However, even when static electricity is discharged from the human body, the short fibers 13 on which antistatic treatment has been performed keep a proper resistance value, so that charge is transferred slowly. Thus, a discharging speed is reduced and does not produce strong spark discharge.

Therefore, even when the flexible pipe 2 is touched by a speaker whose body is charged, noise caused by spark discharge can be eliminated on an audio signal generated by the microphone 5.

The above explanation described the present invention in accordance with the illustrated example. The specific configuration is not limited to this configuration. For example, the microphone device 1 may be either a stand microphone placed on a base such as a desk or a headset microphone as long as the microphone device 1 comprises the flexible pipe 2. Further, the flock layer 11 may be either partially or entirely formed on the flexible pipe.

The present application is based on, and claims priority from, Japanese Application Serial Number JP2004-193457, filed Jun. 30, 2004, the disclosure of which is hereby incorporated by reference herein in its entirety.

1. A microphone device, comprising:
a unit body for housing a necessary circuit on a base end of a flexible pipe, and
a microphone including a microphone unit on a top end of the flexible pipe,
wherein the flexible pipe has a flock layer in which short fibers are electrostatically implanted via a conductive adhesive on a periphery of the flexible pipe, and the flock layer is subjected to antistatic treatment.

2. The microphone device according to claim 1, wherein the antistatic treatment is to apply an antistatic agent capable of dissipating static electricity.
